(19) United States
(12) Patent Application Publication
(10) Pub. No.: US 2007/0156451 A1
(43) Pub. Date: Jul. 5, 2007

(54) System and method for portable display of relevant healthcare information

(76) Inventor: David Thomas Gering, Waukesha, WI (US)

Correspondence Address: MCANDREWS HELD & MALLOY, LTD, 500 WEST MADISON STREET, SUITE 3400, CHICAGO, IL, 60661, US

(21) Appl. No.: 11/325,738

(22) Filed: Jan. 5, 2006

(51) Int. Cl. G06Q 10/00; G06Q 50/00

(52) U.S. Cl. 705/2

(57) ABSTRACT

Certain embodiments of the present invention provide systems and methods for portable display of relevant information for healthcare applications. Certain embodiments include a portable computing device having a plurality of records including icons, waveforms, and/or parameters related to medical cases. In certain embodiments, medical images are reduced to icons for display with related parameters and/or waveforms, for example. In certain embodiments, the device computes a correlation between at least two of the plurality of records. In certain embodiments, the device sorts the plurality of records based at least in part on relevance. In certain embodiments, correlation is computed based on the parameters, the waveforms, and/or image content of the icons. In certain embodiments, the device facilitates viewing and manipulation of the correlated records. In certain embodiments, a support module is configured to process the plurality of records to generate a relevant set of records for access via the device.

### BACKGROUND OF THE INVENTION

The present invention generally relates to portable display of relevant information for healthcare applications. In particular, certain embodiments of the present invention relate to content-based correlation of data records for portable display in relation to a healthcare case or application.

A clinical or healthcare environment is a crowded, demanding environment that would benefit from organization and improved ease of use of imaging systems, data storage systems, and other equipment used in the healthcare environment. A healthcare environment, such as a hospital or clinic, encompasses a large array of professionals, patients, and equipment. Personnel in a healthcare facility must manage a plurality of patients, systems, and tasks to provide quality service to patients. Healthcare personnel may encounter many difficulties or obstacles in their workflow.

A variety of distractions in a clinical environment may frequently interrupt medical personnel or interfere with their job performance. Furthermore, workspaces, such as a radiology workspace, may become cluttered with a variety of monitors, data input devices, data storage devices, and communication device, for example. Cluttered workspaces may result in efficient workflow and service to clients, which may impact a patient's health and safety or result in liability for a healthcare facility. Data entry and access is also complicated in a typical healthcare facility.

Healthcare environments, such as hospitals or clinics, include clinical information systems, such as hospital information systems (HIS) and radiology information systems (RIS), and storage systems, such as picture archiving and communication systems (PACS). Information stored may include patient medical histories, imaging data, test results, diagnosis information, management information, and/or scheduling information, for example. The information may be centrally stored or divided at a plurality of locations. Healthcare practitioners may desire to access patient information or other information at various points in a healthcare workflow. For example, during surgery, medical personnel may access patient information, such as images of a patient's anatomy, that are stored in a medical information system. Alternatively, medical personnel may enter new information, such as history, diagnostic, or treatment information, into a medical information system during an ongoing medical procedure.

Physicians and other healthcare practitioners often maintain logbooks or notes to help them mentally internalize their clinical experience. This is especially true of young physicians dedicated to learning their craft, as well as researchers, such as a radiologist investigating a new biomarker or imaging protocol. A typical logbook might contain a handwritten record of patient name, exam number and date, a rough sketch of an image, a sketch of a waveform, and/or a handful of parameters, for example. An image sketch serves to refresh a practitioner's memory of a patient's pathology (e.g., location and extent), for example. A waveform captures a characterization of a patient's condition, such as a contrast uptake curve, or a plot of motion over time. Parameters provide a quantitative element to a description, such as tumor volume, percentage changes, or cardiac ejection fraction.

Logbooks are distinctly different from imaging information systems such as a Radiology Information System (RIS) or Picture Archival Communication Systems (PACS). Such systems digitize vast amounts of data, serve an entire institution, and are marketed toward site administrators. Logbooks, in contrast, record only the requisite highlights for triggering one's personal memory, store data for only one physician, and may be marketed directly to individuals.

Logbooks might be relied upon more frequently if they were more convenient and more powerful. Thus, an improved logbook or notetaking system and method would be highly desirable. Additionally, radiologists, physicians, and other healthcare practitioners are faced with data overload when reviewing medical cases. Systems and methods for focusing and reducing data for review would be highly desirable.

### BRIEF SUMMARY OF THE INVENTION

Certain embodiments of the present invention provide systems and methods for portable display of relevant information for healthcare applications. Certain embodiments provide a portable information system for a healthcare application. The system includes a portable computing device including a plurality of records. The records include icons, waveforms, and/or parameters related to medical cases. The records may be correlated, for example. The computing device is configured to display the records.

In certain embodiments, medical images are reduced to icons for display with related parameters and/or waveforms, for example. In certain embodiments, the device computes a correlation between at least two of the plurality of records. Correlation may be implemented using any of a plurality of similarity metrics known to those skilled in the art, for example. In certain embodiments, the device sorts the plurality of records based at least in part on relevance. In certain embodiments, relevance is based on a complete record and/or a subset of categories in a record, for example. In certain embodiments, correlation is computed based on the parameters, the waveforms, and/or image content of the icons, for example. In certain embodiments, the device facilitates viewing and manipulation of the correlated records. In certain embodiments, the device communicates with an external system to request a dataset corresponding to at least one of the plurality of records. In certain embodiments, the device communicates wirelessly with the external system. In certain embodiments, the system also includes a support module configured to process the plurality of records to generate a relevant set of records for access via the device.

Certain embodiments provide a method for content-based correlation of medical data. The method includes processing a medical data set to produce a reduced data set, generating one or more records from the reduced data set, correlating the one or more records based on at least one parameter related to image content, and providing the one or more records for access via a portable computing device.

In certain embodiments, the method also includes sorting the one or more records by relevance to a medical case. In certain embodiments, the method further includes viewing one or more of the one or more records via the portable computing device. In certain embodiments, the method further includes manipulating one or more of the one or more records via the portable computing device. In certain embodiments, the method includes retrieving a full data set related to one of the one or more records. In certain embodiments, the method includes searching the one or more records according to a criterion to identify one or more records satisfying the criterion. In certain embodiments, the correlation step correlates the one or more records based on at least one parameter, and/or at least one waveform, and/or image content, for example. In certain embodiments, the one or more records include at least one of image icons, waveforms, and parameters related to medical cases, for example. In certain embodiments, the method further includes reducing at least one medical image to at least one icon for display with at least one of related parameters and waveforms.

Certain embodiments provide a computer-readable storage medium including a set of instructions for execution on a processor. The set of instructions includes a records processing routine configured to process medical data to generate one or more records, a correlation routine configured to correlate the one or more records, and a display routine capable of displaying the one or more records. The medical data includes images and related information, for example.

In certain embodiments, the one or more records include icons, waveforms, and/or parameters, for example, related to medical cases. In certain embodiments, medical images are reduced to icons for display with at least one of related parameters and waveforms, for example. In certain embodiments, the correlation routine sorts the one or more records. In certain embodiments, the correlation routine correlates the one or more records based on at least one of parameters, the waveforms, and image content from the one or more records, for example. In certain embodiments, the set of instructions further includes a support routine configured to process the one or more records to generate a relevant set of records for access via the display routine.

### BRIEF DESCRIPTION OF SEVERAL VIEWS OF THE DRAWINGS

FIG. 1 illustrates an exemplary portable information system used in accordance with an embodiment of the present invention.

FIG. 2 illustrates information flow between the iLog, sLog, and an external system in accordance with an embodiment of the present invention.

FIG. 3 depicts a prototypical set of records displayed on an iLog in accordance with an embodiment of the present invention.

FIG. 4 illustrates a flow diagram for a method for content-based correlation and display of medical data used in accordance with an embodiment of the present invention.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF THE INVENTION

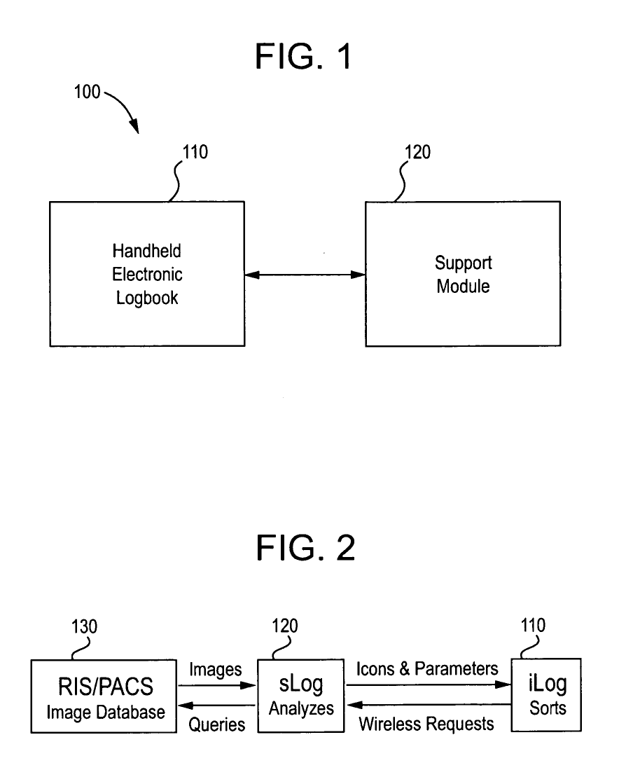

Certain embodiments provide a portable information access system. Certain embodiments provide a portable information entry system. FIG. 1 illustrates an exemplary portable information system 100 used in accordance with an embodiment of the present invention. The system 100 includes a portable computing device, such as a handheld electronic logbook 110, referred to herein as iLog 110, and an iLog support module 120 (referred to herein as sLog 120) that supports one or more iLogs 110. The sLog 120 may be software, hardware and/or firmware for execution on and/or with a workstation, server, and/or other processing system, for example.

In certain embodiments, the iLog 110 includes image and data storage capability, still and cine image playback, information search capability, and/or medical image segmentation capability, for example. The iLog 110 allows information display and may also allow information entry and/or modification, for example. The iLog 110 may include a camera for photographic and/or video input, for example. The iLog 110 includes a screen, such as an LCD or touchscreen, and may include an input device, such as a touchpad, touchscreen, keyboard, stylus, joystick, trackball, wheel, button, mouse and/or other input device. The iLog 110 may also include one or more speakers and/or microphones for audio output and/or input, for example. The iLog 110 and sLog 120 may be integrated or the iLog 110 may communicate with the sLog 120 and/or other external system via a wired, wireless, infrared, and/or other connection, for example.

FIG. 2 illustrates information flow between the iLog 110, sLog 120, and an external system 130, such as a RIS/PACS and/or other information system. The sLog 120 interfaces with RIS/PACS by querying for new exams to be analyzed. In order to process an exam, images are transferred over the network, such as by DICOM retrieval, from the RIS/PACS to the sLog 120. The sLog 120 may analyze the image(s) to reduce the amount of image data down to representative image(s), referred to hereafter as icons. The sLog 120 may also compute certain characteristic waveforms and parameters, for example. Icons, waveforms, parameters, and/or other information form a record suitable for convenient searching, sorting, and/or correlating, for example. The records may be downloaded into an iLog 110 for browsing, especially ordered by cross-correlation or other similarity metrics, for example. After manipulating records with the iLog 110, the user may decide to view an exam in full detail, and such a request may be sent wirelessly from the iLog 110 to the sLog 120, which in turn, queries the RIS/PACS for the original image data, for example.

Content of a record may be designed to be useful for capturing an essence of a medical case, and, therefore, may vary by application, patient and/or circumstance, for example. For example, with oncology for brain and breast applications, icons may include a central slice through a tumor, a segmented image of the slice, a parametric mapping of the slice, a 3-D rendering of the tumor, and a waveform of contrast uptake over time. Parameters may include percentage enhancement and relative blood flow, for example. As another example, with cardiac analysis using magnetic resonance imaging (MRI), icons may include a key slice through pathology and its segmentation, as with oncology, but the waveform may instead graph left ventricular volume throughout the cardiac cycle. The parameters may include ejection fraction and measurements such as myocardial thickness, for example.

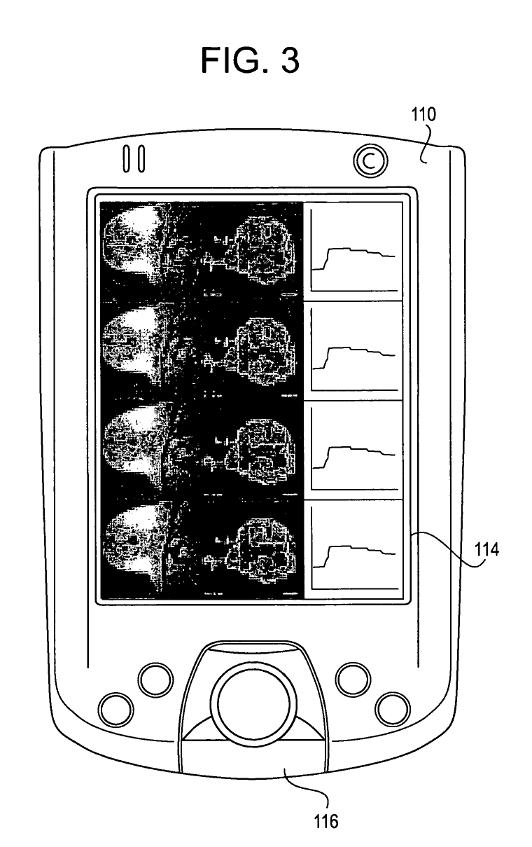

The image in FIG. 3 depicts a prototypical set of records displayed on an iLog 110 via the display 114. Each row of icons corresponds to a separate medical case. Thus, for example, a record may include x-ray image(s), ultrasound image(s), other modality image(s), waveform(s), and/or patient data. Information in a record may be displayed graphically and/or textually on the iLog 110. One or more controls 116, such as buttons, touchscreen, stylus, keypad, keyboard, wheel, trackball, joystick, mousing device, etc., may be used to retrieve, modify, and/or otherwise interact with the information on the display 114, for example.

In an embodiment, images are segmented and analyzed by the sLog 120 to produce icons and parameters. Records may be sorted on the iLog 110 by any given parameter, for example. In an embodiment, records are not sorted by the image content of the icons. That is, the icons are displayed to provide a visual reference for the physician.

Additionally, in an embodiment, the records may be sorted by total relevance to a given case. Therefore, a correlation between records or medical cases is computed using the ensemble of all parameters, rather than simply a sort by any single parameter.

In addition, in an embodiment, the icons are included in the correlation computation. A “distance” between any two images or waveforms may be measured by Euclidean distance (e.g., the method of least squares) or non-Euclidean metrics (e.g., application-dependent geodesics), or mutual information, or other similarity metrics known to those skilled in the art, for example.

In an embodiment, the processed images (e.g., segmentations and parametric images) are included in the correlation computation. In an embodiment, the handheld iLog 110 may be used to compute the correlation. Alternatively, the sLog 120 may maintain the database and compute the correlations based at least in part on user interface commands transferred from the iLog 110 to the sLog 120 over a network, such as a wireless network.

Additionally, in embodiment, original image(s) may be incorporated into the correlation computation.

In certain embodiments, the sLog 120 is responsible for attaining an understanding of image content, and the iLog 110 permits this derived knowledge to be manipulated for the purpose of establishing correspondence between various cases, for example.

The processing performed by sLog 120 applies temporal and/or spatial analysis, for example, to segment medical images into a labeling of each voxel (volume element) according to tissue type or function, for example. Temporal analysis takes a set of N characteristics curves (or models), and analyzes a dynamic image by fitting the acquired curve at each spatial location to each of the N models. Probability and/or statistics may be employed to classify the tissue at each location based on the N fitness measurements. Spatial analysis may be used to perform Bayesian classification where spatially varying priors (SVP) are generated from a topological atlas, for example. The algorithm iterates by fitting the topological atlas to the resulting segmentation, regenerating the SVP from the atlas, and then reclassifying based on the SVP, for example.

In certain embodiments, some processing is fully automated, and some processing is accomplished via real-time interaction. Therefore, sLog 120 may be implemented as software running on a previously existing workstation or a dedicated computer with a user interface, for example.

A result of sLog 120 processing may be segmentations and/or parametric images, for example. In certain embodiments, the processed images may be shrunk to form small icons to be passed on to the iLog 110 for visual inspection, for example. In certain embodiments, the segmentations and parametric images are neither stored in a database nor passed to the iLog 110. Instead, the processed images are analyzed to compute parameters, for example. Parameters may describe waveform shapes, and/or include measurements made on structural geometry discovered from the segmentation (e.g.: location, distance, thickness, volume, etc).

Once the sLog 120 has derived information from scanned images, the information is transferred to the iLog 110 in the form of compact record(s). The iLog 110 is responsible for sorting the records with real-time interaction based on categories requested by a user, for example. Categories may include patient name, exam number, exam date, and/or any of the parameters computed by sLog 120, for example. The iLog 110 may correlate records based one category and/or any or all information contained in the record(s). In certain embodiments, correlation computation may vary by application, and may be based on a distance metric computed between sets of parameters, in addition to rule-based inference, for example.

In addition to holding data computed by the sLog 120, the iLog's records may hold notes entered by a physician and/or other user that are useful for comparing relevant cases, for example. Examples include a course of treatment taken and a patient's outcome. If the iLog 110 is implemented as software running on a handheld computer, then additional features (e.g., calendar, email, web-browsing, etc.) may be available for personal productivity.

In certain embodiments, the iLog 110 provides a portable solution. For example, the iLog 110 alleviates a need to sit at a certain station or within a certain room to access data. Unlike a RIS/PACS or AW workstation, the iLog 110 may be conveniently taken from an office into an exam room, a reading room, and/or an operating room, for example.

In certain embodiments, the iLog 110 improves productivity of individual physicians and/or other users by storing cases of personal interest, thus making navigation through the data more responsive and intuitive. Physicians and/or other users may further personalize the data by adding case-by-case comments to the iLog's records, for example.

In certain embodiments, the iLog 110 presents the data sorted by relevance to a case at hand, automatically correlated by characteristic images, waveforms, and/or parameters, for example. The iLog 110 may perform data mining to provide information to a user.

In operation, for example, the iLog 110 or other similar portable computing device includes a plurality of records including icons, waveforms, and parameters related to medical cases, for example. The computing device may correlate and display the records, for example. The sLog 120 may process one or more records to generate a relevant set of records for access via the iLog 110, for example. In certain embodiments, the iLog 110 and/or sLog 120 reduce medical images to icons for display with related parameters, waveforms, and/or other information, for example. The iLog 110 and/or sLog 120 may compute a correlation between two or more of the plurality of records. The correlation may be computed based on parameters, waveforms, image content, and/or other data, for example. In certain embodiments, the iLog 110 and/or sLog 120 may facilitate viewing and/or manipulation of records, such as correlated records. The iLog 110 and/or sLog 120 may sort one or more records based on one or more criteria, such as relevance. In certain embodiments, relevance may be based on a complete record and/or a subset of categories in a record, for example. In certain embodiments, the iLog 110 and/or sLog 120 may communicate with an external system to request a dataset corresponding to at least one of the plurality of records, for example.

In certain embodiments, the iLog 110 and/or sLog 120 may be used to reduce data overload and focus on relevant data for a particular patent, for example. By tracking patient and/or disorder data over time, a physician or other healthcare practitioner may make more informed decisions regarding diagnosis and/or treatment, for example. The system 100 may store historical records and help a healthcare practitioner provide personalized healthcare by encompassing a patient's total health, for example. Using intelligent correlation of data, the iLog 110 may provide a user with information, such most important images and/or test results, to remind the user about the patient and/or condition, for example. Additionally, a user may benefit from having a log of his or her experience for convenient access. The system 100 may automatically find relevant images and/or information based on a search or other criteria, for example.

In certain embodiments, the sLog 120 running on a server or other processing device generates and/or retrieves the information, and the iLog 110 displays the information, for example. Alternatively or in addition, the iLog 110 may generate and/or retrieve the information. In certain embodiments, processing may be shared between the iLog 110 and the sLog 120 depending upon configuration and available processing capability, for example. In certain embodiments, information being viewed on a workstation or server and/or related information may be retrieved and displayed on the iLog 110.

Certain embodiments take a large quantity of data and reduce it to a smaller, relevant set of data for review. In certain embodiments, relevant information may be correlated with patient history and/or other information, such as lab results, test data, and/or notes, to identify one or more best matches for review.

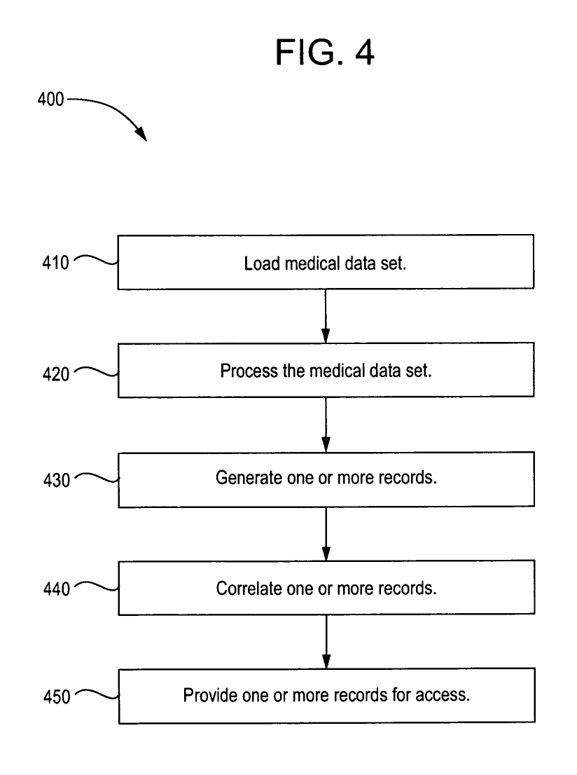

FIG. 4 illustrates a flow diagram for a method 400 for content-based correlation and display of medical data used in accordance with an embodiment of the present invention. First, at step 410, a medical data set is loaded. The medical data set may be loaded onto the sLog 120 or the iLog 110, for example. Then, at step 420, the medical data set is processed. The medical data set is processed to reduce the amount of medical data and produce a reduced medical data set.

At step 430, one or more records are generated from the reduced medical data set. The records may include image(s), image icon(s), data, parameter(s), and/or waveform(s) related to a patient, anatomy, disorder, and/or case, for example. Related medical data may be grouped into one or more records, for example.

At step 440, one or more records are correlated. Records may be correlated based on one or more parameters, such as parameters related to image content and/or other data, for example. In certain embodiments, one or more records are correlated based on at least one parameter, at least one waveform, and/or image content, for example. In certain embodiments, current records may be correlated with historical records, for example. A record for a patient and/or malady may be correlated with other record(s) for the patient and/or malady, for example.

In certain embodiments, additional processing is performed in relation to the record(s). For example, one or more records may be sorted, such as by relevance to a medical case or parameter. In certain embodiments, one or more records may be searched according to one or more criteria, for example. Record(s) may be searched, and one or more records satisfying the one or more criterion may be identified. In certain embodiments, one or more medical images may be reduced to one or more icons. Icons may be displayed separately on the iLog 110 display and/or in conjunction with other information, such as related parameter(s) and/or waveform(s), for example.

At step 450, one or more records are provided for access, such as via a portable computing device (e.g., the iLog 110). Record(s) may be viewed, manipulated, and/or otherwise modified, for example. In certain embodiments, a full data set may be retrieved in relation to a record, for example.

In certain embodiments, systems and/or methods may be implemented on a computer-readable storage medium that includes a set of instructions for execution on a computer and/or other processing device. A computer-readable medium may include a floppy disk, a hard disk, a CD, a CD-ROM, a DVD, a DVD-ROM, a magnetic storage, an optical storage, a flash memory, an electronic storage card, a random access memory, a read only memory, and/or other information storage unit, for example.

In certain embodiments, a set of instructions may include a records processing routine, for example. The records processing routine may be configured to process medical data, such as image(s), waveform(s), parameter(s), and/or other related information, to generate one or more records, for example. The set of instructions may include a correlation routine configured to correlate one or more records based on one or more automatically and/or user-defined criteria, for example. Additionally, the set of instructions maybe include a display routine capable of displaying one or more records, for example. The display routine may allow display of information to be customized by and/or for a particular user and/or group of users, for example. Furthermore, the set of instructions may include a support routine configured to process one or more records to generate a relevant set of records for access via the display routine, for example.

In certain embodiments, one or more records may include icon(s), other image content, waveform(s), and/or parameter(s), for example. In certain embodiments, medical images may be reduced to icons for display with related parameter(s), waveform(s), and/or other data in one or more records, for example.

In certain embodiments, the correlation routine sorts one or more records, for example. In certain embodiments, the correlation routine correlates one or more records based on parameter(s), waveform(s), and/or image content from one or more records, for example.

Thus, certain embodiments process medical imagery to reduce a large amount of data down to small records consisting of icons, waveforms, and parameters, for example. Certain embodiments compute a correlation between records, allowing the records to be sorted by relevance. Certain embodiments base the relevance measurement not only on a single category, but also on the complete record, or on a subset of categories within a record, for example. Certain embodiments compute the correlation based on parameters alone, or based on both parameters and waveforms, or based on parameters, waveforms, and the image content of the icons, for example. Certain embodiments allow a user to view and manipulate the correlated records on a handheld computer. A user may use the handheld computer to wirelessly place a request to a workstation to view the full dataset that corresponds to a specific record, for example. A user may use a workstation to place a wireless request to view records related to a specific case or patient on the handheld, for example.

For example, an electronic logbook, such as a portable electronic logbook computing device, provides a portable, automated, searchable source for medical records. The electronic logbook allows physicians and/or other healthcare practitioners to view their prior cases sorted by relevance to a case at hand, automatically correlated by characteristic images, waveforms, and/or parameters, for example. Thus, certain embodiments augment a healthcare practitioner's ability to access their history of clinical experience to benefit the case at hand.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A portable information system for a healthcare application, said system comprising:
a portable computing device including a plurality of records, wherein said records include at least one of icons, waveforms, and parameters related to medical cases and wherein said records are correlated, and said computing device is configured to display said records.

2. The system of claim 1, wherein medical images are reduced to icons for display with at least one of related parameters and waveforms.

3. The system of claim 1, wherein said device computes a correlation between at least two of said plurality of records.

4. The system of claim 3, wherein said device sorts said plurality of records based at least in part on relevance.

5. The system of claim 4, wherein said relevance is based on at least one of a complete record and a subset of categories in a record.

6. The system of claim 3, wherein said correlation is computed based on at least one of said parameters, said waveforms, and image content of said icons.

7. The system of claim 3, wherein said device facilitates viewing and manipulation of said correlated records.

8. The system of claim 1, wherein said device communicates with an external system to request a dataset corresponding to at least one of said plurality of records.

9. The system of claim 8, wherein said device communicates wirelessly with said external system.

10. The system of claim 1, further comprising a support module configured to process said plurality of records to generate a relevant set of records for access via said device.

11. A method for content-based correlation of medical data, said method comprising:
processing a medical data set to produce a reduced data set;
generating one or more records from said reduced data set;
correlating said one or more records based on at least one parameter related to image content; and
providing said one or more records for access via a portable computing device.

12. The method of claim 11, further comprising sorting said one or more records by relevance to a medical case.

13. The method of claim 11, further comprising viewing one or more of said one or more records via the portable computing device.

14. The method of claim 11, further comprising manipulating one or more of said one or more records via the portable computing device.

15. The method of claim 11, further comprising retrieving a full data set related to one of said one or more records.

16. The method of claim 11, further comprising searching said one or more records according to a criterion to identify one or more records satisfying said criterion.

17. The method of claim 11, wherein said correlating step correlates said one or more records based on at least one of said at least one parameter, a waveform, and image content.

18. The method of claim 11, wherein said one or more records include at least one of image icons, waveforms, and parameters related to medical cases.

19. The method of claim 11, further comprising reducing at least one medical image to at least one icon for display with at least one of related parameters and waveforms.

20. A computer-readable storage medium including a set of instructions for execution on a processor, the set of instructions comprising:
a records processing routine configured to process medical data to generate one or more records, said medical data including images and related information;
a correlation routine configured to correlate said one or more records; and
a display routine capable of displaying said one or more records.

21. The set of instructions of claim 20, wherein said one or more records include at least one of icons, waveforms, and parameters related to medical cases.

22. The set of instructions of claim 21, wherein medical images are reduced to icons for display with at least one of related parameters and waveforms in said one or more records.

23. The set of instructions of claim 20, wherein said correlation routine sorts said one or more records.

24. The set of instructions of claim 20, wherein said correlation routine correlates said one or more records based on at least one of parameters, said waveforms, and image content from said one or more records.

25. The set of instructions of claim 20, further comprising a support routine configured to process said one or more records to generate a relevant set of records for access via said display routine.
